(19) United States
(12) Patent Application Publication
(10) Pub. No.: US 2026/0178860 A1
(43) Pub. Date: Jun. 25, 2026

(54) RELAY APPARATUS, CONTROL METHOD, AND SYSTEM

(71) Applicant: SEIKO EPSON CORPORATION, TOKYO (JP)

(72) Inventor: Yu Suzuki, SHIOJIRI-SHI (JP)

(21) Appl. No.: 19/432,250

(22) Filed: Dec. 24, 2025

(30) Foreign Application Priority Data
Dec. 25, 2024 (JP) 2024-228530

(51) Int. Cl. G06K 15/02; G06F 3/12

(52) U.S. Cl. CPC G06K 15/1803; G06F 3/1205; G06F 3/1258

(57) ABSTRACT

According to an aspect of the present disclosure, there is provided a relay apparatus including a first communication unit communicably connected to an information processing apparatus, a second communication unit communicably connected to a first printing apparatus or a second printing apparatus, and a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.

The present application is based on, and claims priority from JP Application Serial Number 2024-228530, filed Dec. 25, 2024, the disclosure of which is hereby incorporated by reference herein in its entirety.

### BACKGROUND

### 1. Technical Field

The present disclosure relates to a relay apparatus, a control method, and a system.

### 2. Related Art

There has been a POS system including a printing apparatus such as a receipt printer. JP-A-2021-154620 discloses a business printing system including an operation terminal and a business printer coupled to the operation terminal.

JP-A-2021-154620 is an example of the related art.

In the POS system of the related art, when the printing apparatus is replaced because of, for example, failure of a printing mechanism, kitting work for adapting a print command of the operation terminal to a new printing apparatus, which is a replacement destination, is performed. Since the kitting work includes a change of a setting value corresponding to a printing mechanism of the new printing apparatus, a service person goes to the site and performs the kitting work. For this reason, downtime in which the printing apparatus cannot be used sometimes increases.

### SUMMARY

According to an aspect of the present disclosure, there is provided a relay apparatus including: a first communication unit communicably connected to an information processing apparatus; a second communication unit communicably connected to a first printing apparatus or a second printing apparatus different from the first printing apparatus; and a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.

According to another aspect of the present disclosure, there is provided a control method for a computer connected to a first communication unit communicably connected to an information processing apparatus and a second communication unit communicably connected to a first printing apparatus or a second printing apparatus different from the first printing apparatus, the computer executing processing of: generating a print command corresponding to the first printing apparatus based on a print command of the information processing apparatus when the first printing apparatus is connected to the second communication unit; and generating a print command corresponding to the second printing apparatus based on a print command of the information processing apparatus when the second printing apparatus is connected to the second communication unit.

According to still another aspect of the present disclosure, there is provided a system including: an information processing apparatus; a first printing apparatus or a second printing apparatus different from the first printing apparatus; and a relay apparatus including a first communication unit communicably connected to the information processing apparatus, a second communication unit communicably connected to the first printing apparatus or the second printing apparatus, and a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.

### BRIEF DESCRIPTION OF THE DRAWINGS

FIG. 1 is a block diagram of a POS system according to an embodiment.

FIG. 2 is a sequence diagram illustrating an operation example of the POS system according to the embodiment.

FIG. 3 is a diagram illustrating an example of model information.

FIG. 4 is a diagram illustrating an example of a print command.

### DESCRIPTION OF EMBODIMENTS

Hereinafter, an embodiment according to the present disclosure is explained in detail with reference to the drawings. However, explanation detailed more than necessary is sometimes omitted. For example, detailed explanation of already well-known matters or redundant explanation about substantially the same configuration is sometimes omitted.

In the explanation of the present disclosure, general abbreviations are sometimes used for the explanation. For example, POS is an abbreviation for Point of Sales. USB is an abbreviation for Universal Serial Bus. CPU is an abbreviation for Central Processing Unit. MPU is an abbreviation for Micro Processor Unit. RAM is an abbreviation for Random Access Memory. ROM is an abbreviation for Read Only Memory. VID is an abbreviation for vendor identifier. PID is an abbreviation for product identifier. JSON is an abbreviation for JavaScript Object Notation. Note that JavaScript is a registered trademark.

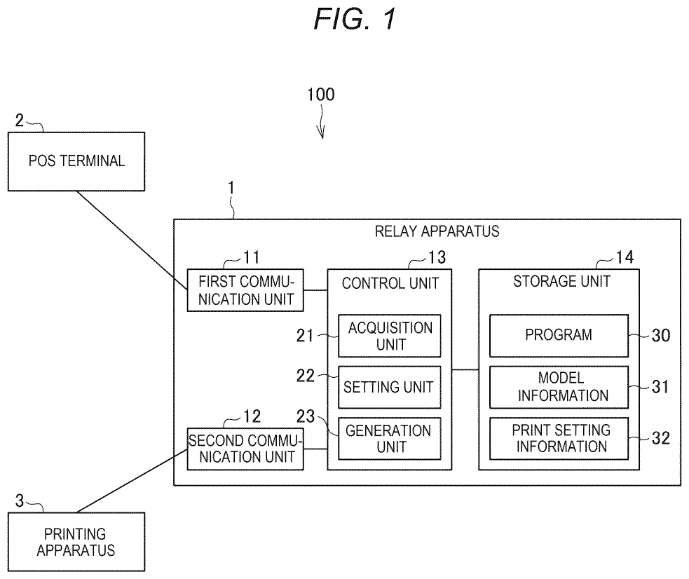

FIG. 1 is a block diagram of a POS system according to the embodiment. As illustrated in FIG. 1, a POS system 100 includes a relay apparatus 1, a POS terminal 2, and a printing apparatus 3. The POS terminal 2 is an example of an information processing apparatus. The POS system 100 is an example of a system. For example, the POS system 100 may be a business system or an information processing system in which the POS terminal 2 is replaced with a personal computer, a tablet terminal, a smartphone, a server apparatus, or the like. The POS system 100 is an example of a system. For example, the system may be a business system including a personal computer serving as an information processing apparatus, the relay apparatus 1, and the printing apparatus 3.

The relay apparatus 1 is an apparatus that is connected between the POS terminal 2 and the printing apparatus 3 and relays communication between the POS terminal 2 and the printing apparatus 3. The relay apparatus 1 is called, for example, hub box. An apparatus relayed by the relay apparatus 1 is not limited to the above configuration. For example, the relay apparatus 1 may have a configuration to which POS peripheral equipment is connectable. As an example, when the POS terminal 2 is a tablet terminal, the relay apparatus 1 may be configured to be capable of connecting, by wire or radio, a handy scanner and a keyboard to which a commodity code and the like are input, a touch panel device for displaying a touch panel screen, and a cash drawer for storing cash.

The POS terminal 2 is a terminal apparatus that performs checkout processing in the POS system 100. The POS terminal 2 includes a handy scanner and a keyboard to which a commodity code and the like are input, a touch panel device for displaying a touch panel screen, and a cash drawer for storing cash.

The POS terminal 2 includes a communication interface such as a USB interface. The POS terminal 2 is communicably connected to equipment such as the relay apparatus 1 via the communication interface. The communication interface of the POS terminal 2 may be connected to the equipment such as the relay apparatus 1 either by wire or radio.

The printing apparatus 3 is, for example, a receipt printer. As the printing apparatus 3, an impact printer of a dot impact type or a non-impact printer such as a thermal printer of a direct thermal type or a thermal transfer type can be used. The non-impact printer is not limited to the direct thermal type or the thermal transfer type. A printer of a printing type such as an inkjet type or an electrophotographic type may be applied.

The printing apparatus 3 includes a communication interface such as a USB interface. The printing apparatus 3 is communicably connected to equipment such as the relay apparatus 1 via the communication interface. The communication interface of the printing apparatus 3 may be connected to the equipment such as the relay apparatus 1 either by wire or radio.

In the POS system 100, the printing apparatus 3 in which a printing mechanism or the like has failed is replaced with a new printing apparatus 3. More specifically, a user of the POS system 100 removes the printing apparatus 3 connected to the relay apparatus 1 and connects a new printing apparatus 3 to the relay apparatus 1 to replace the printing apparatus 3.

In the following explanation, the printing apparatus 3 before the replacement is referred to as first printing apparatus 3a and the printing apparatus 3 after the replacement is referred to as second printing apparatus 3b. For example, the first printing apparatus 3a is a printing apparatus connected to the relay apparatus 1 when the POS system 100 is installed. The second printing apparatus 3b is a printing apparatus being a replacement destination that is prepared separately from the first printing apparatus 3a and is replaced by removing the first printing apparatus 3a after the installation. When not particularly distinguished, the first printing apparatus 3a and the second printing apparatus 3b are referred to as printing apparatus 3.

The relay apparatus 1 includes a first communication unit 11, a second communication unit 12, a control unit 13, and a storage unit 14.

The first communication unit 11 is a communication interface communicably connected to the POS terminal 2. For example, a USB interface or the like can be applied to the first communication unit 11. The first communication unit 11 may be connected to the POS terminal 2 by either wire or radio.

The second communication unit 12 is a communication interface communicably connected to the printing apparatus 3. For example, a USB interface or the like can be applied to the second communication unit 12. The second communication unit 12 may be connected to the printing apparatus 3 by either wire or radio.

The control unit 13 is a processor that executes programs, such as a CPU or an MPU. The control unit 13 reads and sequentially executes programs 30 stored in the storage unit 14 to execute various kinds of processing in cooperation with hardware and software.

The storage unit 14 is a storage device including, for example, a RAM, a ROM, and a flash memory. The storage unit 14 stores model information 31 and print setting information 32 besides the programs 30 explained above.

The model information 31 is information concerning a model specific to the printing apparatus 3. More specifically, the model information 31 includes information related to the specifications of the printing apparatus 3 such as a language used by the printing apparatus 3, paper width of print paper to be printed, and a printing range. The model information 31 also includes function information indicating a functional configuration of the printing apparatus 3. The model information 31 is an example of specific information.

The function information indicating the functional configuration of the printing apparatus 3 includes a name of at least one function of the printing apparatus 3. Examples of the function of the printing apparatus 3 include a cut function for print paper, a slip print function, a verification function, and a magnetic ink character recognition function.

The print setting information 32 is information indicating print settings at the time when a print command corresponding to the printing apparatus 3 connected to the second communication unit 12 is generated. More specifically, the print setting information 32 includes print settings corresponding to the specifications of the printing apparatus 3 and the functional configuration of the printing apparatus 3.

The control unit 13 implements the functions of an acquisition unit 21, a setting unit 22, and a generation unit 23 with the various kinds of processing by the programs 30 explained above.

The acquisition unit 21 is a processing unit that acquires information such as the model information 31 from the printing apparatus 3 connected to the second communication unit 12. Specifically, when recognizing that the printing apparatus 3 has been connected to the second communication unit 12, the acquisition unit 21 inquires of the printing apparatus 3 about identification information via the second communication unit 12. The acquisition unit 21 acquires the identification information of the printing apparatus 3 with a reply from the printing apparatus 3 to the inquiry. Examples of the identification information of the printing apparatus 3 include a VID for identifying a manufacturer of the printing apparatus 3 and a PID uniquely allocated to the printing apparatus 3.

When recognizing that the printing apparatus 3 is connected to the second communication unit 12, the acquisition unit 21 inquires of the printing apparatus 3 about the model information 31 via the second communication unit 12. The acquisition unit 21 acquires the model information 31 of the printing apparatus 3 with a reply from the printing apparatus 3 to the inquiry. The acquisition unit 21 stores the acquired model information 31 in the storage unit 14.

The setting unit 22 is a processing unit that performs, based on the model information 31, print setting for generating a print command corresponding to the printing apparatus 3 connected to the second communication unit 12.

More specifically, the setting unit 22 reads information concerning the specifications of the printing apparatus 3, such as the language used by the printing apparatus 3, the paper width of the print paper to be printed, and the print range, included in the model information 31. Subsequently, the setting unit 22 stores, in the storage unit 14, print settings corresponding to the specifications of the printing apparatus 3 while including the print settings in the print setting information 32. For example, the setting unit 22 includes, in the print setting information 32, print settings in which the language in use, the paper width of the print paper to be printed, and the print range are adjusted to the specifications of the printing apparatus 3.

The setting unit 22 reads function information indicating the functional configuration of the printing apparatus 3 included in the model information 31. Subsequently, the setting unit 22 stores, in the storage unit 14, print settings corresponding to the functional configuration of the printing apparatus 3 while including the print settings in the print setting information 32. For example, for a function of the printing apparatus 3, the setting unit 22 includes a print setting for enabling the function in the print setting information 32.

The generation unit 23 is a processing unit that generates, based on a print command of the POS terminal 2 connected via the first communication unit 11, a print command corresponding to the printing apparatus 3 connected to the second communication unit 12. The generation unit 23 outputs the generated print command to the printing apparatus 3 via the second communication unit 12.

More specifically, when receiving the print command of the POS terminal 2, the generation unit 23 analyzes content of the print command. Subsequently, the generation unit 23 converts the analyzed content of the print command based on the print setting information 32 to match the specifications and functions of the printing apparatus 3. Subsequently, the generation unit 23 outputs the print command including the converted content to the printing apparatus 3 via the second communication unit 12 as a print command to the printing apparatus 3.

For example, when the language used by the printing apparatus 3 is Japanese, the generation unit 23 converts a character code of print data included in the print command of the POS terminal 2 into a character code of Japanese. The generation unit 23 converts the print data included in the print command of the POS terminal 2 into print data in which a line feed position and like are adjusted to match a paper width and a print range in the printing apparatus 3.

When the print command of the POS terminal 2 includes an instruction to execute a predetermined function, the generation unit 23 specifies the function instructed to be executed out of functions enabled in the print setting information 32. Subsequently, the generation unit 23 incorporates the instruction to execute the specified function into the print command including the converted print data. When the function instructed to be executed is absent in the functions enabled in the print setting information 32, the generation unit 23 notifies the POS terminal 2 via the first communication unit 11 that the function instructed to be executed is not installed in the printing apparatus 3.

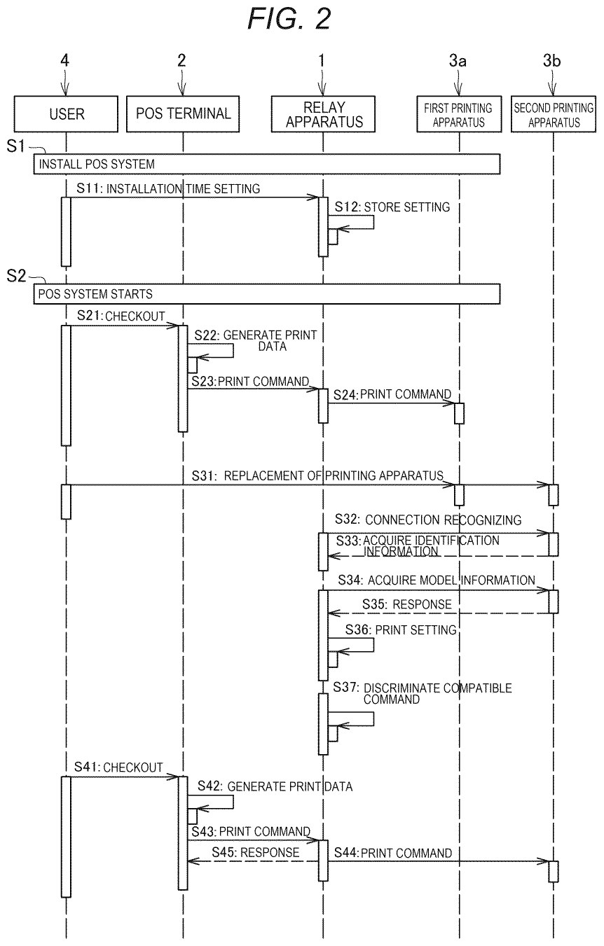

FIG. 2 is a sequence diagram illustrating an operation example of the POS system 100 according to the embodiment. As illustrated in FIG. 2, first, the user 4 connects the POS terminal 2 to the first communication unit 11 of the relay apparatus 1, connects the first printing apparatus 3a to the second communication unit 12 of the relay apparatus 1, and installs the POS system 100 (S1).

Here, the user 4 performs installation time setting in the relay apparatus 1 via a terminal apparatus such as the POS terminal 2 (S11). Specifically, the user 4 causes the terminal apparatus such as the POS terminal 2 to execute a program for performing initial setting, such as an installer, to store setting content of the initial setting of the relay apparatus 1 in the storage unit 14 (S12). According to S12, the model information 31 and the print setting information 32 relating to the first printing apparatus 3a are stored in the storage unit 14 of the relay apparatus 1.

After the installation of the POS system 100 is completed in this way, the POS system 100 starts (S2). After the POS system 100 starts, the user 4 performs checkout processing using the POS terminal 2 (S21).

Subsequently, the POS terminal 2 generates print data for printing, for example, a result of the checkout processing (S22). Subsequently, when receiving an operation instruction of a user 4 for print execution or the like, the POS terminal 2 generates a print command including the generated print data and outputs the print command to the relay apparatus 1 (S23).

The generation unit 23 of the relay apparatus 1 converts the print command of the POS terminal 2 into a print command corresponding to the first printing apparatus 3a based on the print setting information 32 relating to the first printing apparatus 3a. Subsequently, the generation unit 23 outputs the converted print command to the first printing apparatus 3a via the second communication unit 12 (S24). Accordingly, the first printing apparatus 3a can print, for example, the result of the checkout processing based on the print command of the POS terminal 2.

It is assumed that, after the start of the POS system 100, the first printing apparatus 3a is replaced with the second printing apparatus 3b because, for example, failure of the printing mechanism has occurred in the first printing apparatus 3a (S31). In this case, the user 4 releases the connection between the first printing apparatus 3a and the second communication unit 12 of the relay apparatus 1 and connects the second printing apparatus 3b prepared anew to the second communication unit 12 of the relay apparatus 1.

When the second printing apparatus 3b is connected to the second communication unit 12, the control unit 13 of the relay apparatus 1 recognizes the connection of the second printing apparatus 3b (S32). Subsequently, the acquisition unit 21 inquires of the second printing apparatus 3b, the connection of which is recognized, about identification information and acquires the identification information (S33).

Subsequently, the acquisition unit 21 inquires of the second printing apparatus 3b about the model information 31 (S34) and receives a response of the model information 31 from the second printing apparatus 3b (S35). Subsequently, the setting unit 22 performs, based on the model information 31 of the second printing apparatus 3b, print setting for generating a print command corresponding to the second printing apparatus 3b (S36).

Subsequently, the setting unit 22 performs, based on the model information 31 of the second printing apparatus 3b, print setting for enabling a print command corresponding to a function of the printing apparatus 3, that is, a compatible command (S37). Accordingly, the compatible command corresponding to the function of the printing apparatus 3 is discriminated as being effective. Subsequently, the setting unit 22 stores contents of the print settings in S36 and S37 in the storage unit 14 as the print setting information 32.

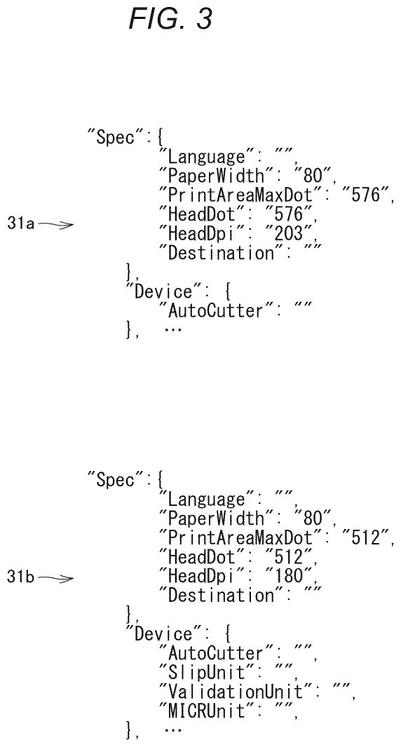

FIG. 3 is a diagram illustrating an example of model information. As illustrated in FIG. 3, first model information 31a and second model information 31b are JSON data in which specifications concerning the printing apparatus 3 are listed in a “Spec” block and functions of the printing apparatus 3 are listed in a “Device” block.

It is assumed that the first model information 31a corresponds to, for example, the first printing apparatus 3a, which is a thermal printer. It is assumed that the second model information 31b corresponds to the second printing apparatus 3b, which is a dot impact printer.

For example, for the specifications concerning the first printing apparatus 3a, the first model information 31a indicates that a paper width is 80 mm and a printing region is 576 dots/203 dots. For the functions of the first printing apparatus 3a, the first model information 31a indicates that there is Auto Cutter, which is a cut function for print paper,.

Therefore, in the print setting based on the first model information 31a, a printing region of a converted print command is set to 576 dots/ 273 dots. A print command for the cut function for the print paper is determined as effective.

For the specifications concerning the second printing apparatus 3b, the second model information 31b indicates that a paper width is 80 mm and a printing region is 512 dots/ 180 dots. For the functions of the second printing apparatus 3b, the second model information 31b indicates that there are Slip Unit, Validation Unit, and MICR Unit besides the Auto Cutter. The Slip Unit corresponds to a slip print function. The Validation Unit corresponds to a verification function. The MICR Unit corresponds to a magnetic ink character recognition function.

Therefore, in the print setting based on the second model information 31b, the printing region of the converted print command is set to 512 dots/180 dots. Print commands for the cut function, the slip print function, the verification function, and the magnetic ink character recognition function for the print paper are determined as effective.

After the print setting for the second printing apparatus 3b is completed, the user 4 performs checkout processing using the POS terminal 2 (S41).

Subsequently, the POS terminal 2 generates print data for printing, for example, a result of the checkout processing (S42). Subsequently, when receiving an operation instruction of the user 4 for print execution or the like, the POS terminal 2 generates a print command including the generated print data and outputs the print command to the relay apparatus 1 (S43).

The generation unit 23 of the relay apparatus 1 converts the print command of the POS terminal 2 into a print command corresponding to the second printing apparatus 3b based on the print setting information 32 relating to the second printing apparatus 3b. Subsequently, the generation unit 23 outputs the converted print command to the second printing apparatus 3b via the second communication unit 12 (S44). Accordingly, the second printing apparatus 3b can print, for example, the result of the checkout processing based on the print command of the POS terminal 2.

When the second printing apparatus 3b does not have a function instructed to be executed by the print command of the POS terminal 2, that is, when the function is not installed, the generation unit 23 of the relay apparatus 1 responds to the POS terminal 2 that the function is not installed (S45). Accordingly, the user 4 can confirm, via, for example, a display unit of the POS terminal 2, that the second printing apparatus 3b is not installed with the function instructed to be executed.

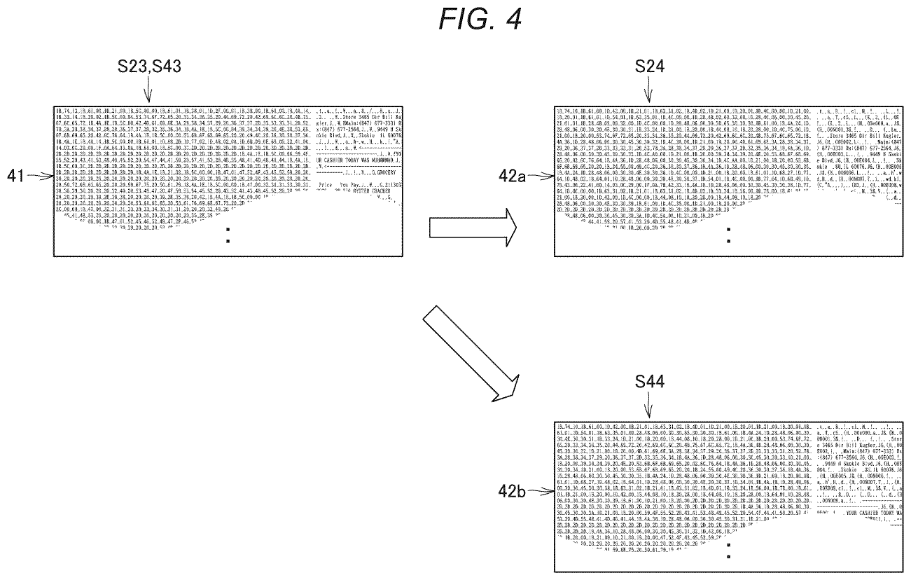

FIG. 4 is a diagram illustrating an example of a print command. As illustrated in FIG. 4, it is assumed that print commands 41 output from the POS terminal 2 to the relay apparatus 1 in S23 and S43 are the same. When the first printing apparatus 3a is connected to the relay apparatus 1, the relay apparatus 1 converts the print command 41 into a print command 42a corresponding to the first printing apparatus 3a based on the print setting information 32 relating to the first printing apparatus 3a. Accordingly, in S24, the relay apparatus 1 outputs the print command 42a corresponding to the first printing apparatus 3a to the first printing apparatus 3a.

When the second printing apparatus 3b is connected to the relay apparatus 1, the relay apparatus 1 converts the print command 41 into a print command 42b corresponding to the second printing apparatus 3b based on the print setting information 32 relating to the second printing apparatus 3b. Accordingly, in S44, the relay apparatus 1 outputs the print command 42b corresponding to the second printing apparatus 3b to the second printing apparatus 3b.

Accordingly, in the POS system 100, printing corresponding to the second printing apparatus 3b can be performed simply by replacing the first printing apparatus 3a, which is connected from the POS terminal 2 via the relay apparatus 1, with the second printing apparatus 3b. That is, in the POS system 100, when the first printing apparatus 3a is replaced with the second printing apparatus 3b, kitting work for adapting the print command 41 of the POS terminal 2 to correspond to the second printing apparatus 3b, which is a replacement destination, is unnecessary.

The embodiment explained above is a preferred embodiment of the present disclosure. However, the present disclosure is not limited to the embodiment, and various modified implementations can be made without departing from the gist of the present disclosure.

For example, in the embodiment explained above, a configuration in which the print setting for the first printing apparatus 3a is performed using the installer when the POS system 100 is installed is exemplified. However, as in the case of the second printing apparatus 3b, the print setting for the first printing apparatus 3a may be performed by the acquisition unit 21 and the setting unit 22 performing the processing in S32 to S37.

In initial setting at the time of installation of the POS system 100, the model information 31 of a plurality of models to be connected to the relay apparatus 1 may be set in the relay apparatus 1 in advance. In this case, the setting unit 22 can perform print setting by specifying, based on the identification information acquired by the acquisition unit 21, the model information 31 of a model corresponding to the identification information.

In the POS system 100, after the first printing apparatus 3a is replaced with the second printing apparatus 3b, the second printing apparatus 3b may be replaced with another printing apparatus 3. In this case, the second printing apparatus 3b before the replacement is the first printing apparatus 3a and the other printing apparatus 3 is the second printing apparatus 3b.

The functional units of the control unit 13 illustrated in FIG. 1 indicate functional components implemented by cooperation of hardware and software and specific implementation forms of the functional units are not particularly limited. Therefore, hardware individually corresponding to the functional units does not always need be implemented. It is also naturally possible to adopt a configuration in which one processor executes a program to implement functions of a plurality of functional units. A part of functions implemented by software in the embodiment explained above may be implemented by hardware and a part of functions implemented by hardware in the embodiment may be implemented by software.

The program 30 executed by the control unit 13 in order to implement the control method explained above may be provided by being recorded in a recording medium readable by the control unit 13. The recording medium readable by the control unit 13 may be an optical recording medium, a semiconductor memory device, or the like. The program 30 may be provided in a form of a transmission medium that is stored on a computer connected to a network such as the Internet and is provided or distributed by being downloaded through a network.

Processing units of the sequence illustrated in FIG. 2 are divided according to main processing content in order to facilitate understanding of the processing of the control unit 13. The present disclosure is not limited by a way of division and names of the processing units shown in the sequence of FIG. 2. The processing of the control unit 13 can be divided into more processing units according to processing content or can be divided such that one processing unit includes more processing. Processing order of the sequence explained above is not limited to the illustrated example.

### SUMMARY OF THE PRESENT DISCLOSURE

A summary of the present disclosure is appended below.

### Appendix 1

A relay apparatus including: a first communication unit communicably connected to an information processing apparatus; a second communication unit communicably connected to a first printing apparatus or a second printing apparatus different from the first printing apparatus; and a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.

Accordingly, when the first printing apparatus is replaced with the second printing apparatus, kitting work for adapting a print command of the information processing apparatus to the second printing apparatus, which is a replacement destination, is unnecessary. Therefore, it is easy to replace a printing apparatus.

### Appendix 2

The relay apparatus described in Appendix 1, further including: an acquisition unit configured to acquire specific information of the second printing apparatus from the second printing apparatus when the second printing apparatus is communicably connected to the second communication unit; and a setting unit configured to perform, based on the acquired specific information, print setting relating to generation of a print command corresponding to the second printing apparatus.

Accordingly, when the first printing apparatus is replaced with the second printing apparatus, by connecting the second printing apparatus to the second communication unit, the print setting related to the generation of the print command corresponding to the second printing apparatus can be performed. For this reason, it is possible to easily perform the print setting corresponding to the second printing apparatus.

### Appendix 3

The relay apparatus described in Appendix 2, wherein the specific information includes at least one of a language, a paper width, and a printing range in the second printing apparatus.

Accordingly, it is possible to perform the print setting corresponding to the second printing apparatus for at least one of the language, the paper width, and the printing range.

### Appendix 4

The relay apparatus described in Appendix 2 or 3, wherein the specific information includes function information indicating whether the second printing apparatus has a predetermined function, and the setting unit performs, based on the function information included in the acquired specific information, setting concerning whether to enable a print command for the predetermined function.

Accordingly, the print setting relating to the generation of the print command corresponding to the second printing apparatus can be performed to enable the function of the second printing apparatus.

### Appendix 5

The relay apparatus according to Appendix 4, wherein the function information includes at least one of a cut function, a slip print function, a verification function, and a magnetic ink character recognition function for print paper.

Accordingly, at least one of the cut function, the slip print function, the verification function, and the magnetic ink character recognition function for the print paper can be set to enable the functions of the second printing apparatus.

### Appendix 6

The relay apparatus described in Appendix 4 or 5, wherein, when generating the print command corresponding to the second printing apparatus based on the print command of the information processing apparatus, when a print command for a function not set to effective is included in the print command of the information processing apparatus, the generation unit notifies the information processing apparatus that the second printing apparatus does not have the function.

Accordingly, the information processing apparatus can confirm that the print command of the information processing apparatus includes the print command for the function that the second printing apparatus does not have.

### Appendix 7

A control method for a computer connected to a first communication unit communicably connected to an information processing apparatus and a second communication unit communicably connected to a first printing apparatus or a second printing apparatus different from the first printing apparatus, the computer executing processing of: generating a print command corresponding to the first printing apparatus based on a print command of the information processing apparatus when the first printing apparatus is connected to the second communication unit; and generating a print command corresponding to the second printing apparatus based on a print command of the information processing apparatus when the second printing apparatus is connected to the second communication unit.

Accordingly, when the first printing apparatus is replaced with the second printing apparatus, kitting work for adapting a print command of the information processing apparatus to the second printing apparatus, which is a replacement destination, is unnecessary. Therefore, it is easy to replace a printing apparatus.

### Appendix 8

A system including: an information processing apparatus; a first printing apparatus or a second printing apparatus different from the first printing apparatus; and a relay apparatus including a first communication unit communicably connected to the information processing apparatus, a second communication unit communicably connected to the first printing apparatus or the second printing apparatus, and a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.

Accordingly, when the first printing apparatus is replaced with the second printing apparatus, kitting work for adapting a print command of the information processing apparatus to the second printing apparatus, which is a replacement destination, is unnecessary. Therefore, it is easy to replace a printing apparatus.

What is claimed is:

1. A relay apparatus comprising:
a first communication unit communicably connected to an information processing apparatus;
a second communication unit communicably connected to a first printing apparatus or a second printing apparatus different from the first printing apparatus; and
a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.

2. The relay apparatus according to claim 1, further comprising:
an acquisition unit configured to acquire specific information of the second printing apparatus from the second printing apparatus when the second printing apparatus is communicably connected to the second communication unit; and
a setting unit configured to perform, based on the acquired specific information, print setting relating to generation of a print command corresponding to the second printing apparatus.

3. The relay apparatus according to claim 2, wherein the specific information includes at least one of a language, a paper width, and a printing range in the second printing apparatus.

4. The relay apparatus according to claim 2, wherein
the specific information includes function information indicating whether the second printing apparatus has a predetermined function, and
the setting unit performs, based on the function information included in the acquired specific information, setting concerning whether to enable a print command for the predetermined function.

5. The relay apparatus according to claim 4, wherein the function information includes at least one of a cut function, a slip print function, a verification function, and a magnetic ink character recognition function for print paper.

6. The relay apparatus according to claim 4, wherein, when generating the print command corresponding to the second printing apparatus based on the print command of the information processing apparatus, when a print command for a function not set to effective is included in the print command of the information processing apparatus, the generation unit notifies the information processing apparatus that the second printing apparatus does not have the function.

7. A control method for a computer connected to a first communication unit communicably connected to an information processing apparatus and a second communication unit communicably connected to a first printing apparatus or a second printing apparatus different from the first printing apparatus,
the computer executing processing of: generating a print command corresponding to the first printing apparatus based on a print command of the information processing apparatus when the first printing apparatus is connected to the second communication unit; and generating a print command corresponding to the second printing apparatus based on a print command of the information processing apparatus when the second printing apparatus is connected to the second communication unit.

8. A system comprising:
an information processing apparatus;
a first printing apparatus or a second printing apparatus different from the first printing apparatus; and
a relay apparatus including a first communication unit communicably connected to the information processing apparatus, a second communication unit communicably connected to the first printing apparatus or the second printing apparatus, and a generation unit configured to generate a print command corresponding to the first printing apparatus based on a print command of the information processing apparatus when the first printing apparatus is connected to the second communication unit and generate a print command corresponding to the second printing apparatus based on a print command of the information processing apparatus when the second printing apparatus is connected to the second communication unit.
